(19) United States
(12) Patent Application Publication
(10) Pub. No.: US 2009/0184081 A1
(43) Pub. Date: Jul. 23, 2009

(54) Temperature-sensing feeding bottle structure

(76) Inventors: Ming-Jung Wu, Chiayi City (TW); Jian-Hong Chen, Puzih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/010,229

(22) Filed: Jan. 23, 2008

(51) Int. Cl. A61J 9/02; A61J 9/00

(52) U.S. Cl. 215/11.2; 215/11.1

(57) ABSTRACT

A feeding bottle includes a body, a temperature sensing and measuring plate on a lateral wall portion of the body, and a plate-shaped warning device covered by the temperature sensing and measuring plate; the temperature sensing and measuring plate can change colors with temperature to indicate the temperature for the users such as the parents, nursing persons, and diners; the warning device can give a certain kind of sound effect according to the temperature so that the parents/nursing persons can easily make sure that the food contents of the feeding bottle isn't too hot before they feed little children/persons with disabilities; little children, the elderly, and persons with visual disabilities also can be directly warned by the warning sound effects given by the warning device if the temperature is too high.

### BACKGROUND OF THE INVENTION

1. Field of the Invention

The present invention relates to a temperature-sensing feeding bottle structure, more particularly one, which has a temperature sensing and measuring plate, and a plate-shaped warning device on the body; the temperature sensing and measuring plate can change colors with temperature, and the warning device can give a certain kind of sound effect according to the temperature so that the parents/nursing persons can know the temperature easily, and persons with disabilities can be directly warned by the sound effects if the temperature is too high.

2. Brief Description of the Prior Art

Little children, the elderly, and persons with disabilities usually can't dine by themselves, and therefore need to be fed by other people. The eaters/feeders usually measure the temperature of the foods in order to make sure that the foods are neither too hot nor too cool before they eat/feed the foods to little children, the elderly, and persons with disabilities. Various dining implements are used in dining, e.g. thermos bottles, chopsticks, forks, spoons, bowls, feeding bottles, and dishes.

Referring to FIG. 3, a feeding bottle 4 has a nipple 41 on the opening, and is marked with graduations 42, e.g. 20, 30, 40, 50, 60, and 70 ml, to indicate the volume of the contents. Such a feeding bottle is found to have a drawback: The feeding bottle isn't equipped with a temperature device. Therefore, the feeders have to use a thermometer to measure the temperature of the contents of the feeding bottle to make sure that the temperature of the contents is moderate before they feed the contents to little children, the elderly, and persons with disabilities.

To provide consumers with convenience, a certain manufacturer makes a temperature-sensing drinking bottle, which is made of PC materials, and has a temperature-sensing plate stuck thereon; the plate is made of a material comprising temperature-sensing powder, and is divided into several sections, which can change colors with temperature to indicate the temperature of the bottle; the temperature-sensing plate has a smaller thickness than the feeding bottle, and is buried in the feeding bottle when the feeding bottle is formed so that the inner side of the plate is between the inner and the outer side of the bottle, and the outer side of the plate is at the same level as the outer side of the bottle. The above-mentioned feeding bottle can indicate the temperature of its contents, and therefore is relatively safe to use. Furthermore, it can be sterilized by high temperature.

However, other people such as the nursing persons still have to make sure that the temperature is moderate before the user (eater) has the contents of the feeding bottle if the user has visual disabilities. Therefore, there is room for improvement.

### SUMMARY OF THE INVENTION

It is a main object of the present invention to provide a feeding bottle, which allows the parents/nursing persons/eaters to know the temperature of the contents without feeling the bottle.

A feeding bottle according to an embodiment of the present invention has a body, which has a first recess on a lateral wall portion. The feeding bottle further includes a temperature sensing and measuring plate fitted on the first recess of the body, and a plate-shaped warning device covered by the temperature sensing and measuring plate. The temperature sensing and measuring plate is made of plastic materials with temperature-sensing powder added thereto, and can change colors with temperature; for example, the temperature sensing and measuring plate will be such a color as to indicate low temperature when the temperature is within a range of 20° C. to 22° C.; the plate will be such a color as to indicate moderate temperature when the temperature is within a range of 22° C. to 28° C.; the plate will be such a color as to indicate high temperature when the temperature is within a range of 28° C. to 40° C.

It is another object of the present invention to provide a feeding bottle, which can give warning sound effects to warn people with visual disabilities if the food contents of the bottle are too hot.

To achieve the above object, the feeding bottle is equipped with a warning device, which is fitted on the lateral side of the body, and which is an IC with temperature sensing function and vocal warning function, capable of giving a certain kind of sound effect according to the temperature; for example, the warning device will give such a sound effect as to indicate low temperature when the temperature is within a range of 20° C. to 22° C.; it will give such a sound effect as to indicate moderate temperature when the temperature is within a range of 22° C. to 28° C.; it will give such a sound effect as to indicate high temperature when the temperature is within a range of 28° C. to 40° C.

Furthermore, the above temperature sensing and measuring plate is stuck over an outer side of the warning device to protect the warning device from water and damage.

### BRIEF DESCRIPTION OF THE DRAWINGS

The present invention will be better understood by referring to the accompanying drawings, wherein:

FIG. 1 is an exploded perspective view of the present invention,

FIG. 2 is a sectional view of the present invention, and

FIG. 3 is a perspective view of the prior art.

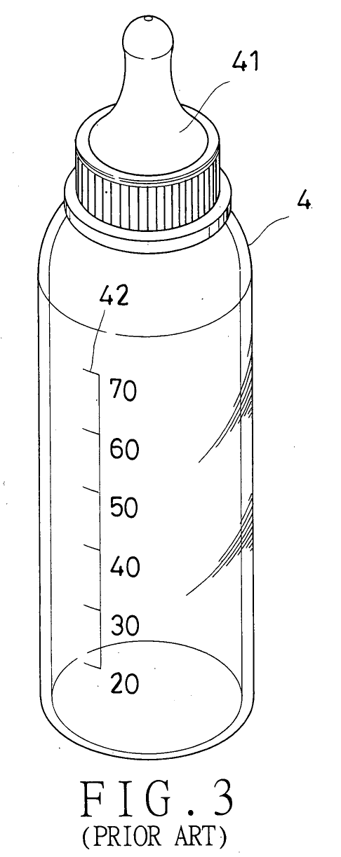

### DETAILED DESCRIPTION OF THE PREFERRED EMBODIMENTS

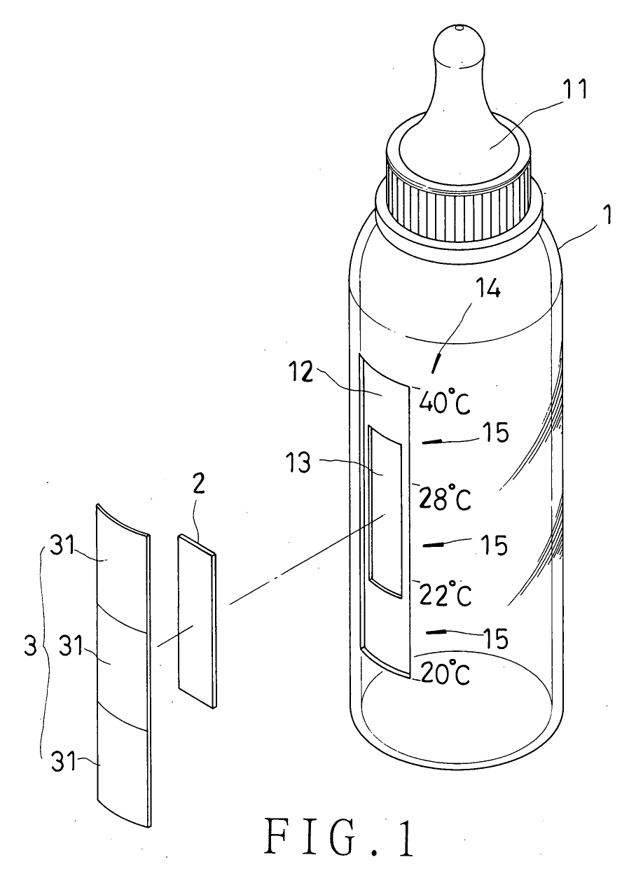

Referring to FIG. 1, a preferred embodiment of a temperature-sensing feeding bottle of the present invention consists of a body 1, a warning device 2, and a temperature sensing and measuring plate 3.

The body 1 has a nipple 11 on a top thereof, and a first recess 12 on a lateral wall portion thereof; the first recess 12 is rectangular, and extends in the direction of a longest side of the body 1 of the feeding bottle with short sides of the first recess 12 being on a same horizontal level as a radius of the body 1, and long sides of the first recess 12 being parallel to an axial direction of the body 1. The body 1 of the feeding bottle further has a second rectangular recess 13 within the first recess 12; the second recess 13 is similar to the first recess 12, and has a smaller width and a smaller length than the first recess 12. Short sides of the second recess 13 are parallel to the short sides of the first recess 12, and long sides of the second recess 13 are parallel to the long sides of the first recess 12. The body 1 is marked with graduations 14 next to the first recess 12, which are 20° C., 22° C., 28° C., and 40° C. respectively from a lowermost one to an uppermost one; thus, there is an intermediate area 15 between every two nearest ones of the graduations 14.

The warning device 2 is an IC (integrated circuit) having temperature-sensing function and vocal function, and is rectangular plate-shaped, and fitted on the second recess 13 of the body 1 of the feeding bottle. The warning device 2 can give a certain kind of vocal message according to the temperature. For example, the warning device 2 will give a vocal warning message, e.g. “temperature is too low”, to indicate that the contents of the feeding bottle are too cold if the temperature is between 20° C. and 22° C. The warning device 2 will give a vocal message, e.g. “temperature is moderate” to indicate that the temperature of the contents is moderate if the temperature is between 22° C. and 28° C. And, the warning device 2 will give a vocal warning message, e.g. “temperature is too high” to indicate that the contents are too hot if the temperature is between 28° C. and 40° C.

The temperature sensing and measuring plate 3 is made of plastic materials having temperature-sensing powder added thereto, and is fitted on the first recess 12 of the body 1. The temperature sensing and measuring plate 3 has a similar (rectangular) shape to the first recess 12. The temperature sensing and measuring plate 3 is divided into several sections 31, which adjoin the intermediate areas 15 of the body 1 respectively. The various sections 31 of the temperature sensing and measuring plate 3 will change colors with temperature; the section 31 adjoining the intermediate section 15 between 20° C. and 22° C. will change into low-temperature colors, e.g. ice blue, under low temperature range of 20° C. to 22° C.; the section 31 adjoining the intermediate section 15 between 22° C. and 28° C. will change into moderate-temperature colors, e.g. orange yellow, under temperature range of 22° C. to 28° C.; the section 31 adjoining the intermediate section 15 between 28° C. and 40° C. will change into high-temperature colors, e.g. fire red, under temperature range of 28° C. to 40° C.

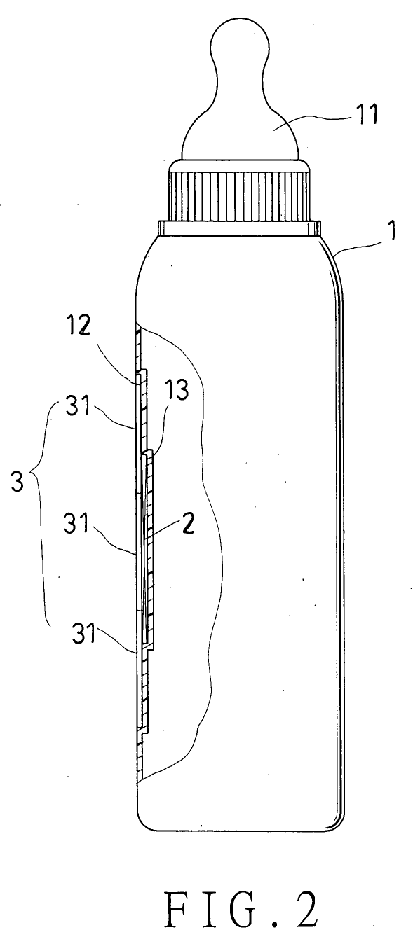

In assembly, referring to FIGS. 1 and 2, the warning device 2 is fitted on the second recess 13 of the body 1, and the temperature sensing and measuring plate 3 is fitted on the first recess 12 of the body 1 to cover the warning device 2, with the various sections 31 of the plate 3 adjoining the intermediate areas 15 of the body 1 respectively. Next, the temperature sensing and measuring plate 3 is secured on the first recess 12 of the body 1 by means of ultra-sonic wave, thus sealing the first recess 12 and preventing water from flowing onto the warning device 2.

Referring to FIG. 2, after liquid foods, e.g. milk and drinking water, are put into the feeding bottle, the warning device 2 and the temperature sensing and measuring plate 3 will sense and measure the temperature of the liquid food. Next, the warning device 2 will give a certain vocal warning message, and change colors according to the temperature of the liquid foods so that the parents/nursing persons can know the temperature of the contents of the feeding bottle easily, and the little children, the elderly, and persons with disabilities can be directly warned by means of the vocal warning messages from the warning device 2 if the temperature of the contents of the feeding bottle is too low or too high.

From the above description, it can be seen that the present invention has the following advantages over the prior art:

1. The parents/nursing persons can know the temperature of the contents of the feeding bottle through the color of the temperature sensing and measuring plate, and therefore can easily make sure that the contents aren't too hot without feeling the bottle.

2. If the diner is a little child, the elderly or a person with disabilities, he/she can be directly warned by means of the vocal warning messages given by the warning device if the temperature of the contents of the feeding bottle is too low or too high.

3. The temperature sensing and measuring plate is waterproof and high-temperature resistant, and is stuck on the lateral wall portion of the body of the feeding bottle by means of ultra-sonic wave, and therefore can't be detached from the bottle, and can protect the warning device from water, thus preventing the warning device from getting damaged.

What is claimed is:

1. A temperature-sensing feeding bottle structure, comprising
a body,
a warning device fitted on a lateral wall portion of the body to give warning sounds, and
a temperature sensing and measuring plate over an outer side of the warning device, the temperature sensing and measuring plate being capable of changing colors with temperature.

2. The temperature-sensing feeding bottle structure as claimed in claim 1, wherein the body has a first recess on the lateral wall portion, and the temperature sensing and measuring plate is stuck on the first recess by means of ultra-sonic wave;
the temperature sensing and measuring plate being rectangular; the first recess being rectangular, extending in a direction of a longest side of the body of the feeding bottle with short sides of the first recess being on a same horizontal level as a radius of the body, and long sides of the first recess being parallel to an axial direction of the body.

3. The temperature-sensing feeding bottle structure as claimed in claim 2, wherein the body has a rectangular second recess within the first recess, and the warning device is rectangular plate-shaped, and fitted on the second recess;
the second recess being similar to the first recess; the second recess having a smaller width and a smaller length than the first recess; short sides of the second recess being parallel to the short sides of the first recess; long sides of the second recess being parallel to the long sides of the first recess.

4. The temperature-sensing feeding bottle structure as claimed in claim 1, wherein the warning device will give such a sound effect as to indicate a low temperature when temperature is low; the warning device will give such a sound effect. as to indicate a moderate temperature when temperature is moderate; the warning device will give such a sound effect as to indicate a high temperature when temperature is high.

5. The temperature-sensing feeding bottle structure as claimed in claim 4, wherein said low temperature ranges from 20° C. to 22° C.

6. The temperature-sensing feeding bottle structure as claimed in claim 4, wherein said moderate temperature ranges from 22° C. to 28° C.

7. The temperature-sensing feeding bottle structure as claimed in claim 4, wherein said high temperature ranges from 28° C. to 40° C.

8. The temperature-sensing feeding bottle structure as claimed in claim 1, wherein the temperature sensing and measuring plate will be such a color as to indicate a low temperature when temperature is low; the temperature sensing and measuring plate will be such a color as to indicate a moderate temperature when temperature is moderate; the temperature sensing and measuring plate will be such a color as to indicate a high temperature when temperature is high.

9. The temperature-sensing feeding bottle structure as claimed in claim 8, wherein said low temperature ranges from 20° C. to 22° C.

10. The temperature-sensing feeding bottle structure as claimed in claim 8, wherein said moderate temperature ranges from 22° C. to 28° C.

11. The temperature-sensing feeding bottle structure as claimed in claim 8, wherein said high temperature ranges from 28° C. to 40° C.

12. The temperature-sensing feeding bottle structure as claimed in claim 1, wherein the lateral wall portion of the body is marked with a plurality of graduations;
there being an intermediate area between every two nearest ones of the graduations;
the temperature sensing and measuring plate being divided into a plurality of sections, which are next to the intermediate areas of the body respectively.
